(19) United States
(12) Patent Application Publication
(10) Pub. No.: US 2006/0124554 A1
(43) Pub. Date: Jun. 15, 2006

(54) Use of aqueous dispersions containing ethylene copolymer wax

(75) Inventors: Andreas Fechtenkotter, Ludwigshafen (DE); Andreas Deckers, Flomborn (DE); Michael Ehle, Ludwigshafen (DE); Siegfried Gast, Ludwigshafen (DE); Wolfgang Kasel, Nubloch (DE); Frank-Olaf Mahling, Mannheim (DE); Wilhelm Weber, Neustadt (DE); Walter Schneider, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/560,363

(22) PCT Filed: Jun. 8, 2004
(86) PCT No.: PCT/EP04/06165

§ 371 Date: Dec. 12, 2005

(30) Foreign Application Priority Data
Jun. 11, 2003 (DE) 103 26 630.5

(51) Int. Cl. C02F 1/52

(52) U.S. Cl. 210/732

(57) ABSTRACT

Use of aqueous dispersions comprising at least one at least partially neutralized ethylene copolymer wax selected from among ethylene copolymer waxes which comprise, as comonomers in copolymerized form, (A) from 26.1 to 39% by weight of at least one ethylenically unsaturated carboxylic acid and (B) from 61 to 73.9% by weight of ethylene, and ethylene copolymer waxes which comprise, in copolymerized form, (A′) from 20.5 to 38.9% by weight of at least one ethylenically unsaturated carboxylic acid, (B′) from 60 to 79.4% by weight of ethylene and (C′) from 0.1 to 15% by weight of at least one ethylenically unsaturated carboxylic ester, as auxiliaries for wastewater treatment.

The present invention relates to the use of aqueous dispersions comprising at least one at least partially neutralized ethylene copolymer wax selected from among ethylene copolymer waxes which comprise, as comonomers in copolymerized form,
(A) from 26.1 to 39% by weight of at least one ethylenically unsaturated carboxylic acid and
(B) from 61 to 73.9% by weight of ethylene,
and ethylene copolymer waxes which comprise, in copolymerized form,
(A′) from 20.5 to 38.9% by weight of at least one ethylenically unsaturated carboxylic acid,
(B′) from 79.4 to 60% by weight of ethylene and
(C′) from 0.1 to 15% by weight of at least one ethylenically unsaturated carboxylic ester,
   as auxiliaries for wastewater treatment.

In wastewater treatment, an important step is to convert solids from a finely dispersed phase into a modification which can be readily filtered off (“flocs”). To aid flocculation, use is generally made of flocculants. An important class of flocculants is made up of inorganic salts, for example aluminum salts or iron salts, but these can give rise to the formation of colloidal precipitates. Examples of another class of flocculants are organic polymers such as hydrolyzed starches. An overview may be found, for example, in Ullmann's Encyclopedia of Industrial Chemistry, 5^{th} edition, keyword “flocculants”, Vol. A11, p. 251, Verlag Chemie Weinheim (1988).

While flocculants which consist of inorganic salts can be used mainly as such, i.e. in crystalline form, flocculants comprising organic polymers are predominantly used in the form of their aqueous dispersions.

For economic reasons, it is desirable to develop flocculants which are particularly effective. Here, properties such as the rate of flock formation, stability of the flocks, completeness of flocculation and residual water content of the flocculated material play a role. Furthermore, flocculants should have a satisfactory shelf life and be easy to use.

It is known from JP 50-14150 that aqueous solutions of ethylene-acrylic acid copolymers having an acrylic acid content of 9.3 mol % can be used to precipitate Mn²⁺, Hg²⁺ and Cd²⁺ from aqueous solutions.

It is an object of the present invention to provide new flocculants which have an improved use profile.

We have found that this object is achieved by use of the aqueous dispersions defined at the outset as auxiliaries for wastewater treatment. Furthermore, we have found a process for preparing the aqueous dispersions defined at the outset. Furthermore, we have found a process for wastewater treatment, and also the dispersions defined at the outset.

In the following, the term wastewater refers not only to domestic sewage but also to contaminated water originating from, for example, industrial operations, mining operations, paper machines, manufacture of building materials or metal processing. For the purposes of the present invention, wastewater can contain, for example, organic materials in dissolved or colloidal form or inorganic salts. Wastewater in the context of the present invention can previously have been subjected to one or more pretreatment steps. Thus, wastewater in the context of the present invention can have been freed of coarse particles of waste by means of, for example, a rake.

In the following, the term work-up refers to the removal of at least part of the dissolved or colloidal organic materials or inorganic salts present in the wastewater. In the following, work-up preferably involves flocculation of at least part of the dissolved or colloidal organic materials or inorganic salts present in the wastewater.

Ethylene copolymer waxes used according to the present invention are selected from among ethylene copolymer waxes which comprise, as comonomers in copolymerized form,
(A) from 26.1 to 39% by weight, preferably from 26.3 to 35% by weight, particularly preferably from 26.5 to 38.9% by weight, of at least one ethylenically unsaturated carboxylic acid and
(B) from 61 to 73.9% by weight, preferably from 65 to 73.7% by weight, particularly preferably from 70 to 73.5% by weight, of ethylene,
and ethylene copolymer waxes which comprise, in copolymerized form,
(A′) from 20.5 to 38.9% by weight, preferably from 21 to 28% by weight, of at least one ethylenically unsaturated carboxylic acid,
(B′) from 60 to 79.4% by weight, preferably from 70 to 78.5% by weight, of ethylene and
(C′) from 0.1 to 15% by weight, preferably from 0.5 to 10% by weight, of at least one ethylenically unsaturated carboxylic ester.

For the purposes of the present invention, “comonomers present in copolymerized form” are the proportions of comonomers which are molecularly built into the ethylene copolymer waxes used according to the present invention.

As ethylenically unsaturated carboxylic acid (A) or (A′), preference is given to at least one carboxylic acid of the formula I, 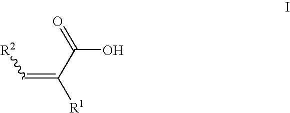
where the variables are defined as follows:
R¹ and R² are identical or different and
R¹ is selected from among hydrogen and
unbranched and branched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular methyl;
R² is selected from among unbranched and branched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular methyl;
and particularly preferably hydrogen.

In an embodiment of the present invention, R¹ is hydrogen or methyl. Very particular preference is given to R¹ being methyl.

In an embodiment of the present invention, R¹ is hydrogen or methyl and R² is hydrogen.

Very particular preference is given to using methacrylic acid as ethylenically unsaturated carboxylic acid of the formula I.

If a plurality of ethylenically unsaturated carboxylic acids are to be used for preparing the ethylene copolymer waxes employed in the dispersions used according to the present invention, it is possible to use two different ethylenically unsaturated carboxylic acids of the formula I, for example acrylic acid and methacrylic acid.

In an embodiment of the present invention, (meth)acrylic acid and maleic acid are used as ethylenically unsaturated carboxylic acid for preparing the ethylene copolymer waxes employed in the dispersions used according to the present invention.

In an embodiment of the present invention, only one ethylenically unsaturated carboxylic acid, in particular acrylic acid or methacrylic acid, is used for preparing the ethylene copolymer waxes employed in the dispersions used according to the present invention.

In an embodiment of the present invention, use is made of ethylene copolymer waxes which comprise, in copolymerized form,
(A′) from 20.5 to 38.9% by weight, preferably from 21 to 28% by weight, of at least one ethylenically unsaturated carboxylic acid,
(B′) from 60 to 79.4% by weight, preferably from 70 to 78.5% by weight, of ethylene and
(C′) from 0.1 to 15% by weight, preferably from 0.5 to 10% by weight, of at least one ethylenically unsaturated carboxylic ester.

Here, ethylenically unsaturated carboxylic acids are the same ethylenically unsaturated carboxylic acids as described above.

At least one ethylenically unsaturated carboxylic ester preferably corresponds to a carboxylic ester of the formula II, 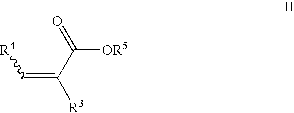
where the variables are defined as follows:
R³ and R⁴ are identical or different and
R³ is selected from among hydrogen and
unbranched and branched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, iso-propyl, n-butyl, isobutyl, sec-butyl and tert-butyl, in particular methyl;
R⁴ is selected from among unbranched and branched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular methyl;
and very particularly preferably hydrogen;
R⁵ is selected from among unbranched and branched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular methyl;
C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl.

In an embodiment of the present invention, R³ is hydrogen or methyl. Very particular preference is given to R³ being hydrogen.

In an embodiment of the present invention, R³ and R⁴ are each hydrogen.

R⁵ is very particularly preferably methyl.

Very particular preference is given to using methyl acrylate as ethylenically unsaturated carboxylic ester of the formula II.

If a plurality of ethylenically unsaturated carboxylic esters are to be used for preparing the ethylene copolymer waxes employed in the dispersions used according to the present invention, it is possible, for example, to use two different ethylenically unsaturated carboxylic esters of the formula II, for example methyl acrylate and methyl methacrylate.

In an embodiment of the present invention, methyl (meth)acrylate is used as ethylenically unsaturated carboxylic ester for preparing the ethylene copolymer waxes employed in the dispersions used according to the present invention.

In an embodiment of the present invention, only one ethylenically unsaturated carboxylic ester and only one ethylenically unsaturated carboxylic acid, in particular acrylic acid or methacrylic acid and methyl (meth)acrylate, are used for preparing the ethylene copolymer waxes employed in the dispersions used according to the present invention.

In an embodiment of the present invention, up to 0.5 part by weight, based on the sum of the above-described comonomers, of further comonomers can be incorporated by copolymerization in the preparation of the ethylene copolymer waxes employed in the dispersions used according to the present invention.

In an embodiment of the present invention, no further comonomers are incorporated by copolymerization in the preparation of the ethylene copolymer waxes employed in the dispersions used according to the present invention.

In an embodiment of the present invention, the ethylene copolymer waxes employed in the dispersions used according to the present invention have a melt flow rate (MFR) in the range from 1 to 50 g/10 min, preferably from 5 to 20 g/10 min, particularly preferably from 7 to 15 g/l 0 min, measured at 160° C. under a load of 325 g in accordance with EN ISO 1133. Their acid number is usually from 100 to 300 mg of KOH/g of wax, preferably from 115 to 230 mg of KOH/g of wax, determined in accordance with DIN 53402.

In an embodiment of the present invention, the ethylene copolymer waxes employed in the dispersions used according to the present invention have a kinematic melt viscosity ν of at least 45,000 mm²/s, preferably at least 50,000 mm²/s.

In an embodiment of the present invention, the melting ranges of the ethylene copolymer waxes employed in the dispersions used according to the present invention are in the range from 60 to 110° C., preferably from 65 to 90° C., determined by DSC in accordance with DIN 51007.

In an embodiment of the present invention, the melting range of the ethylene copolymer wax employed in the dispersions used according to the present invention can be broad and cover a temperature interval from at least 7 to not more than 20° C., preferably from at least 10° C. to not more than 15° C.

In an embodiment of the present invention, the melting points of the ethylene copolymer wax employed in dispersions used according to the present invention are sharp and are in a temperature interval of less than 2° C., preferably less than 1° C., determined in accordance with DIN 51007.

The density is usually from 0.89 to 1.10 g/cm³, preferably from 0.92 to 0.99 g/cm³, determined in accordance with DIN 53479.

Ethylene copolymer waxes employed in the dispersions used according to the present invention can be alternating copolymers or block copolymers or preferably random copolymers.

Ethylene copolymer waxes comprising ethylene and ethylenically unsaturated carboxylic acids and, if desired, ethylenically unsaturated carboxylic esters can advantageously be prepared by free-radical-initiated copolymerization under high-pressure conditions, for example in stirred high-pressure autoclaves or in high-pressure tube reactors. The preparation of the copolymer waxes in stirred high-pressure autoclaves is preferred. Stirred high-pressure autoclaves are known per se and a description may be found in Ullmann's Encyclopedia of Industrial Chemistry, 5^{th} edition, keyword: waxes, vol. A 28, p. 146 ff., Verlag Chemie Weinheim, Basel, Cambridge, N.Y., Tokyo, 1996. In these, the length/diameter ratio is mostly in a range from 5:1 to 30:1, preferably from 10:1 to 20:1. The high-pressure tube reactors which can likewise be employed may also be found in Ullmann's Encyclopedia of Industrial Chemistry, 5^{th} edition, keyword: waxes, vol. A 28, p. 146 ff., Verlag Chemie Weinheim, Basel, Cambridge, N.Y., Tokyo, 1996.

Suitable pressure conditions for the polymerization are from 500 to 4000 bar, preferably from 1500 to 2500 bar. Conditions of this type will hereinafter also be referred to as high pressure. The reaction temperatures are in the range from 170 to 300° C., preferably in the range from 195 to 280° C.

The polymerization can be carried out in the presence of one or more regulators. Regulators used are, for example, hydrogen or at least one aliphatic aldehyde or at least one aliphatic ketone of the formula III 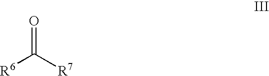
or mixtures thereof.

In this formula, the radicals R⁶ and R⁷ are identical or different and are selected from among
hydrogen;
C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec-butyl and tert-butyl;
C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl.

In a particular embodiment, the radicals R⁶ and R⁷ are covalently joined to one another to form a 4- to 13-membered ring. Thus, R⁵ and R⁷ can together be, for example: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

Further examples of suitable regulators are alkylaromatic compounds, for example toluene, ethylbenzene or one or more isomers of xylene. Further examples of well-suited regulators are paraffins such as isododecane (2,2,4,6,6-pentamethylheptane) or isooctane.

As initiators for the free-radical polymerization, it is possible to use the customary free-radical initiators such as organic peroxides, oxygen or azo compounds. Mixtures of a plurality of free-radical initiators are also useful.

Suitable peroxides selected from among commercially available substances are
didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbo)cyclohexane as an isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropylcarbonate, 2,2-di(tert-butylperoxy)butane or tert-butyl peroxyacetate;
tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropyl monohydroperoxide, cumene hydroperoxide or tert-butyl hydroperoxide; or
dimeric or trimeric ketone peroxides of the formulae IV a to IV c.

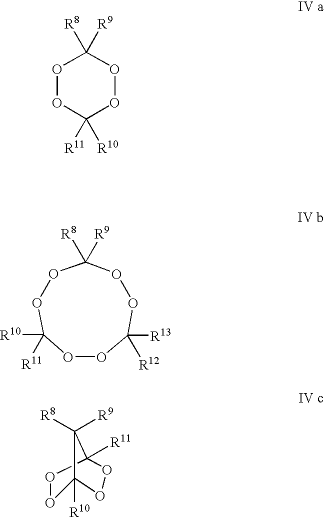

In these formulae, the radicals R⁸ to R¹³ are identical or different and are selected from among
C₁-C₈-alkyl such as methyl, ethyl, n-propyl, isopropyl, n-butyl, sec-butyl, iso-butyl, tert-butyl, n-pentyl, sec-pentyl, isopentyl, n-hexyl, n-heptyl, n-octyl; preferably linear C₁-C₆-alkyl such as methyl, ethyl, n-propyl, n-butyl, n-pentyl, n-hexyl, particularly preferably linear C₁-C₄-alkyl such as methyl, ethyl, n-propyl or n-butyl, very particularly preferably methyl or ethyl;
C₆-C₁₄-aryl such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Peroxides of the formulae IV a to IV c and methods of preparing them are known from EP-A 0 813 550.

As peroxides, di-tert-butyl peroxide, tert-butyl peroxypivalate, tert-butyl peroxyisononanoate or dibenzoyl peroxide or mixtures thereof are particularly useful. An example of an azo compound is azobisisobutyronitrile (“AIBN”). Free-radical initiators are introduced in amounts customary for polymerizations.

Numerous commercially available organic peroxides are admixed with stabilizers before they are sold in order to make them easier to handle. Suitable stabilizers are, for example, white oil and hydrocarbons such as, in particular, isododecane. Under the conditions of the high-pressure polymerization, such stabilizers can act as molecular weight regulators. For the purposes of the present invention, reference to the use of molecular weight regulators means the additional use of further molecular weight regulators other than the stabilizers.

The ratio in which the comonomers are metered in usually does not correspond precisely to the ratio of the units in the ethylene copolymer waxes used according to the present invention, because ethylenically unsaturated carboxylic acids are generally incorporated more easily into ethylene copolymer waxes than is ethylene.

The comonomers are usually metered in jointly or separately.

The comonomers can be compressed to the polymerization pressure in a compressor. In a further embodiment of the process of the present invention, the comonomers are firstly brought to an elevated pressure of, for example, from 150 to 400 bar, preferably from 200 to 300 bar and in particular 260 bar, by means of a pump and then to the actual polymerization pressure by means of a compressor.

The polymerization can, as a matter of choice, be carried out in the absence or presence of solvents, with mineral oils, white oil and other solvents which are present in the reactor during the polymerization and have been used for stabilizing the free-radical initiator(s) not being regarded as solvents for the purposes of the present invention. Suitable solvents are, for example, toluene, isododecane, isomers of xylene.

Dispersions used according to the present invention preferably contain from 1 to 40% by weight, more preferably from 10 to 35% by weight, of one or more ethylene copolymer waxes.

The dispersions used according to the present invention further comprise water which is preferably deionized, i.e. has been purified by distillation or by means of an ion exchanger.

Dispersions used according to the present invention usually further comprise one or more basic substances by means of which the ethylene copolymer wax or waxes is/are at least partially neutralized, for example hydroxides and/or carbonates and/or hydrogencarbonates of alkali metals, or preferably amines such as ammonia and organic amines such as alkylamines, N-alkylethanolamines, alkanolamines and polyamines. Examples of alkylamines are: triethylamine, diethylamine, ethylamine, trimethylamine, dimethylamine, methylamine. Preferred amines are monoalkanolamines, N,N-dialkylalkanolamines, N-alkylalkanolamines, dialkanolamines, N-alkylalkanolamines and trialkanolamines each having from 2 to 18 carbon atoms in the hydroxyalkyl radical and, if applicable, from 1 to 6 carbon atoms in the alkyl radical, preferably from 2 to 6 carbon atoms in the alkanol radical and, if applicable, 1 or 2 carbon atoms in the alkyl radical. Very particular preference is given to ethanolamine, diethanolamine, triethanolamine, methyldiethanolamine, n-butyldiethanolamine, N,N-dimethylethanolamine and 2-amino-2-methylpropanol-1. Ammonia and N,N-dimethylethanolamine are very particularly preferred. Examples of polyamines are: ethylenediamine, tetramethylethylenediamine (TMEDA), diethylenetriamine, triethylenetetramine.

In an embodiment of the present invention, dispersions used according to the present invention contain an amount of basic substance or substances which is such that at least half, preferably at least 60 mol %, of the carboxyl groups of the ethylene copolymer wax or waxes are neutralized.

In an embodiment of the present invention, dispersions used according to the present invention contain an amount of basic substance or substances, in particular amine, which is such that the carboxyl groups of the ethylene copolymer wax or waxes are quantitatively neutralized.

In an embodiment of the present invention, dispersions used according to the present invention can contain more basic substance or substances, in particular amine, than is necessary for complete neutralization of the ethylene copolymer wax or waxes, for example an excess of up to 100 mol %, preferably up to 50 mol %.

Dispersions used according to the present invention usually have a basic pH, preferably a pH of from 7.5 to 14, particularly preferably from 8 to 12 and very particularly preferably from 8.5 to 11.5.

The present invention further provides a process for the treatment of wastewater using one or more of the above-described aqueous dispersions, hereinafter also referred to as the treatment process of the present invention.

The wastewater defined at the outset has a pH in the range from 1 to 12. The treatment process of the present invention is particularly useful for treating wastewater having a pH in the range from 4 to 12, very particularly preferably in the range from 5.5 to 11.

To carry out the treatment process of the present invention, one or more of the above-described dispersions are added to the wastewater to be treated. Preference is given to using from 0.5 to 2000 g, preferably from 10 to 1500 g, of one or more of the above-described aqueous dispersions per cubic meter of wastewater. These are, for example, added to the wastewater or wastewater-containing sludges in the preclarification during the coagulation of solids, during the thickening of the sludge, during the watering of the sludge, in the after-clarification or in the dephosphating. The above-described dispersions can be diluted to a concentration of from 0.1 to 0.3% by weight of ethylene copolymer wax prior to use.

In an embodiment of the present invention, one or more of the above-described dispersions are used together with customary flocculants such as one or more cationic polymers, for example polyvinylpyrrolidone or polyvinylimidazole or copolymers of vinylimidazole and vinylpyrrolidone.

In one embodiment of the present invention, solid which settles after addition of one or more of the above-described dispersions to the wastewater is separated off from the supernatant water, for example by allowing the water to flow away slowly via an overflow. This embodiment is preferred in the preclarification and in the after-clarification.

In another embodiment of the present invention, the solid which floats after addition of one or more of the above-described dispersions to the wastewater is separated off from the water, for example by flotation.

In another embodiment of the present invention, the solid which settles after addition of one or more of the above-described dispersions to the wastewater is separated off from the supernatant water by mechanical methods, for example by filtration using, for example, filters or filter belts or filter presses, e.g. chamber filter presses, by centrifugation, by decantation in, for example, decanters or by screening. This embodiment is preferred particularly in wastewater treatment steps in which a comparatively high content of dry matter is present in the wastewater to be treated, for example in the case of dewatering of sludge or in thickening of sludge.

It has been found that filters have a lower tendency to be blocked by slime in the treatment process of the present invention.

The present invention further provides a process for preparing the aqueous dispersions which are used according to the present invention, hereinafter also referred to as dispersion process of the present invention. The dispersion process of the present invention comprises dispersing one or more ethylene copolymer waxes in water in the presence of at least one basic substance.

The dispersion process of the present invention starts out from one or more of the above-described ethylene copolymer waxes. This or these is/are placed in a vessel, for example a flask, an autoclave or an industrial reaction vessel, and heated and the ethylene copolymer wax or waxes, water and one or more basic substances and, if desired, further constituents are added, with the order of the addition of water and the addition of basic substance(s) and further constituents being able to be chosen at will. If the temperature is above 100° C., it is advantageous to work under superatmospheric pressure and to choose the vessel correspondingly. The emulsion formed is homogenized, for example by mechanical or pneumatic stirring or by shaking. The emulsion is advantageously heated to a temperature above the melting point of the ethylene copolymer wax or waxes. It is advantageously heated to a temperature which is at least 10° C., particularly advantageously at least 30° C., above the melting point of the ethylene copolymer wax or waxes.

If a plurality of different ethylene copolymer waxes are used, the dispersion is heated to a temperature which is above the melting point of the ethylene copolymer wax having the highest melting point. When a plurality of different ethylene copolymer waxes is used, the dispersion is advantageously heated to a temperature which is at least 10° C. above the melting point of the ethylene copolymer wax having the highest melting point. When a plurality of different ethylene copolymer waxes is used, the dispersion is particularly advantageously heated to a temperature which is at least 30° C. above the melting point of the ethylene copolymer wax having the highest melting point.

The aqueous dispersion produced in this way is subsequently allowed to cool.

The aqueous dispersions prepared by the dispersion process of the present invention have a good storage stability and are useful in the above-described treatment process of the present invention.

In a further aspect of the present invention, the invention provides aqueous dispersions comprising at least one at least partially neutralized ethylene copolymer wax selected from among ethylene copolymer waxes which comprise, as comonomers in copolymerized form,
(A) from 26.1 to 39% by weight, preferably from 26.3 to 35% by weight, particularly preferably from 26.5 to 38.9% by weight, of at least one ethylenically unsaturated carboxylic acid and
(B) from 61 to 73.9% by weight, preferably from 65 to 73.7% by weight, particularly preferably from 70 to 73.5% by weight, of ethylene,
and ethylene copolymer waxes which comprise, in copolymerized form,
(A′) from 20.5 to 38.9% by weight, preferably from 21 to 28% by weight, of at least one ethylenically unsaturated carboxylic acid,
(B′) from 60 to 79.4% by weight, preferably from 70 to 78.5% by weight, of ethylene and
(C′) from 0.1 to 15% by weight, preferably from 0.5 to 10% by weight, of at least one ethylenically unsaturated carboxylic ester.

The ethylene copolymer waxes present in the dispersions of the present invention have been described above.

Aqueous dispersions according to the present invention are suitable, for example, for carrying out the treatment process of the present invention.

In a further aspect of the present invention, the invention provides ethylene copolymer waxes which comprise, as comonomers in copolymerized form,
(A) from 26.1 to 39% by weight, preferably from 26.3 to 35% by weight, particularly preferably from 26.5 to 38.9% by weight, of at least one ethylenically unsaturated carboxylic acid and
(B) from 61 to 73.9% by weight, preferably from 65 to 73.7% by weight, particularly preferably from 70 to 73.5% by weight, of ethylene.

In a further aspect of the present invention, the invention provides ethylene copolymer waxes which comprise, as comonomers in copolymerized form,
(A′) from 20.5 to 38.9% by weight, preferably from 21 to 28% by weight, of at least one ethylenically unsaturated carboxylic acid,
(B′) from 79.4 to 60% by weight, preferably from 70 to 78.5% by weight, of ethylene and
(C′) from 0.1 to 15% by weight, preferably from 0.5 to 10% by weight, of at least one ethylenically unsaturated carboxylic ester.

The ethylene copolymer waxes of the present invention and their preparation have been described above.

The invention is illustrated by examples.

### EXAMPLES

1. Preparation of Ethylene Copolymer Wax

Ethylene and methacrylic acid were copolymerized in a high-pressure autoclave as described in the literature (M. Buback et al., Chem. Ing. Tech. 1994, 66, 510). For this purpose, ethylene (12.0 kg/h) was fed continuously into the high-pressure autoclave under the reaction pressure of 1700 bar. In addition, the amount of methacrylic acid indicated in Table 1 was firstly compressed to an intermediate pressure of 260 bar and subsequently fed continuously under the reaction pressure of 1700 bar into the high-pressure autoclave by means of a further compressor. In addition, the amount of initiator solution indicated in Table 1, consisting of tert-butyl peroxypivalate in isododecane (for concentration, see Table 1), was fed continuously under the reaction pressure of 1700 bar into the high-pressure autoclave. Separately therefrom, the amount of regulator indicated in Table 1, consisting of propionaldehyde in isododecane (for concentration, see Table 1), was firstly compressed to an intermediate pressure of 260 bar and subsequently fed continuously under the reaction pressure of 1700 bar into the high-pressure autoclave by means of a further compressor. The reaction temperature was about 220° C. This gave ethylene copolymer wax according to the present invention having the analytical data shown in Table 2.

TABLE 1
Preparation of ethylene copolymer waxes according to the present invention

| | | | | | | | PO in | | Conver- | Output |
|---|---|---|---|---|---|---|---|---|---|---|
| | T_{reactor} | Ethylene | MAA | MAA | PA in ID | | ID | | sion [% | of ECW |
| No. | [° C.] | [kg/h] | [l/h] | [kg/h] | [ml/h] | c(PA) | [l/h] | c(PO) | by wt.] | [kg/h] |
| 1 | 220 | 12 | 1.09 | 1.11 | 30 | 20 | 2.16 | 0.09 | 23 | 3.0 |
| 2 | 220 | 12 | 1.01 | 1.03 | 600 | 25 | 2.10 | 0.07 | 25 | 3.2 |
| 3 | 219 | 12 | 1.03 | 1.05 | — | — | 2.01 | 0.13 | 26 | 3.4 |
| 4 | 199 | 12 | 1.07 | 1.09 | — | — | 1.53 | 0.07 | 18 | 2.4 |
| 5 | 200 | 12 | 0.72 | 0.71 | — | — | 1.18 | 0.07 | 18 | 2.3 |
| C6 | 220 | 12 | 0.53 | 0.56 | — | — | 2.4 | 0.05 | 22 | 2.8 |

T_{reactor} is the maximum internal temperature of the high-pressure autoclave.
Abbreviations: MAA: methacrylic acid, PA: propionaldehyde, ID: isododecane (2,2,4,6,6-pentamethylheptane), PA in ID: solution of propionaldehyde in isododecane, total volume of the solution.
PO: tert-butyl peroxypivalate, ECW: ethylene copolymer wax
c(PA): concentration of PA in ID in percent by volume,
c(PO): concentration of PO in ID in mol/l

The conversion is based on ethylene and is reported in % by weight.

The ethylene copolymer wax C6 is a comparative example.

TABLE 2
Analytical data for ethylene copolymer waxes according to the present invention

| | Ethylene | | Acid number | | | |
|---|---|---|---|---|---|---|
| | content | MAA content | [mg of KOH/g | | | |
| No. | [% by weight] | [% by wt.] | of ECW] | ν [mm²/s] | Tₘₑₗₜ [° C.] | ρ [g/cm] |
| 1 | 71.9 | 28.1 | 183 | 50,000 | 65-80 | n.d. |
| 2 | 73.4 | 26.6 | 173 | 50,000 | 65-80 | n.d. |
| 3 | 73.6 | 26.4 | 172 | 68,000 | 70-80 | n.d. |
| 4 | 61.5 | 38.5 | 251 | 77,000 | 65-75 | 0.990 |
| 5 | 72.8 | 27.2 | 170 | n.d. | 79.3 | 0.961 |
| C6 | 84.7 | 15.3 | 100.5 | 70,000 | 65-80 | 0.953 |

The MFR of ethylene copolymer wax 5 was 10.3 g/10 min, determined under a load of 325 g at 160° C.

n.d.: not determined.

In the above, “content” refers to the proportion of copolymerized ethylene or MAA in the respective ethylene copolymer wax.

ν: dynamic melt viscosity, measured at 120° C. in accordance with DIN 51562.

The contents of ethylene and methacrylic acid in the ethylene copolymer waxes according to the present invention were determined by NMR spectroscopy or by titration (acid number). The acid number of the ethylene copolymer wax was determined titrimetrically in accordance with DIN 53402. The KOH consumption corresponds to the methacrylic acid content of the ethylene copolymer wax.

The density was determined in accordance with DIN 53479. The melting range was determined by DSC (differential scanning calorimetry, differential thermal analysis) in accordance with DIN 51007.

1. Preparation of Dispersions According to the Present Invention and Comparative Experiment

The amount indicated in Table 3 of ethylene copolymer wax obtained as described in Example 1 was placed in a 2 liter autoclave fitted with an anchor stirrer. The amounts of deionized water indicated in Table 3 and the amine indicated in Table 3 were added and the mixture was heated to 120° C. while stirring. After 15 minutes at 120°, the mixture was cooled to room temperature over a period of 15 minutes. The dispersions D1 and D2 according to the present invention and the comparative dispersions D3-C and D4-C were obtained.

TABLE 3
Preparation of dispersions

| | | Amount | | Amout | |
|---|---|---|---|---|---|
| | | of | | of | |
| | | ECW | | amine | Amount of |
| No. | ECW No. | [g] | Amine | [g] | water [g] |
| D1 | 5 | 25.0 | NH₃ | 3.4 | 71.6 |
| D2 | 5 | 20.7 | (CH₃)₂NCH₂CH₂OH | 3.5 | 75.8 |
| D3-C | C6 | 25.0 | NH₃ | 3.4 | 71.6 |
| D4-C | C6 | 20.7 | (CH₃)₂NCH₂CH₂OH | 3.5 | 75.8 |

The “amount of NH₃” refers to the amount of 25% strength by weight aqueous ammonia solution.

2. Treatment of Wastewater: Dewatering of Sludge

The experiment was carried out using the test method disclosed in DE 28 37 017.

Method:

The tests were carried out on a preclarification sludge which had been obtained by sedimentation in the preclarification stage of a water treatment plant of a chemical works. The sludge had a solids content of 2% by weight. The proportion of organic constituents of the sludge solids was 53% by weight.

500 ml of a sample of sludge were placed in a 1 l glass beaker and stirred at a stirrer speed of 50 rpm. 2 ml of the respective dispersion to be examined were subsequently added quickly within a period of 5 seconds. The mixture was then stirred for another 2 minutes and the sludge sample was transferred to a glass filter (diameter: 12 cm) with a polypropylene filter cloth (diameter: 11 cm). The filtrate which ran out was collected in a measuring cylinder and the amount of filtrate running out per unit time was noted.

TABLE 4
Dewatering of sludge

| | | Filtrate which ran out [ml] after | | | | | | |
|---|---|---|---|---|---|---|---|---|
| No. of | ECW | 15 | 30 | 45 | 60 | 90 | 120 | |
| dispersion | No. | sec. | sec. | sec. | sec. | sec. | sec. | Remark |
| / | / | 45 | 70 | 90 | 100 | 130 | 150 | Filtrate |
| | | | | | | | | turbid |
| D4-C | C6 | 60 | 90 | 115 | 130 | 150 | 170 | Filtrate |
| | | | | | | | | clear |
| D2 | 5 | 115 | 165 | 210 | 245 | 300 | 340 | Filtrate |
| | | | | | | | | clear |

sec.: seconds

The experiments were repeated, but the stirrer was switched off after 2 minutes and filtration was omitted. After 5 minutes, the clarity of the supernatant liquid was mesured by means of a Dr. Lange L5500 spectrophotometer.

The following absorbances were obtained:

| | |
|---|---|
| Tapwater | 0.000 |
| Treatment with D4-C | 0.660 |
| Treatment with D1 | 0.500 |
| Treatment with D2 | 0.450 |

1. The use of aqueous dispersions comprising at least one at least partially neutralized ethylene copolymer wax selected from ethylene copolymer waxes which comprise, as comonomers in copolymerized form,
(A) from 26.1 to 39% by weight of at least one ethylenically unsaturated carboxylic acid and
(B) from 61 to 73.9% by weight of ethylene,
and ethylene copolymer waxes which comprise, in copolymerized form,
(A′) from 20.5 to 38.9% by weight of at least one ethylenically unsaturated carboxylic acid,
(B′) from 60 to 79.4% by weight of ethylene and
(C′) from 0.1 to 15% by weight of at least one ethylenically unsaturated carboxylic ester,
as auxiliaries for wastewater treatment.

2. The use according to claim 1, wherein the ethylenically unsaturated carboxylic acid has the formula I, 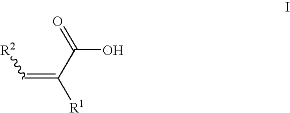
where the radicals are defined as follows:
R¹ is selected from among hydrogen and unbranched or branched C₁-C₁₀-alkyl, and
R² is selected from among hydrogen and unbranched or branched C₁-C₁₀-alkyl.

3. The use according to claim 1, wherein the ethylenically unsaturated carboxylic ester has the formula II, 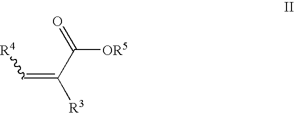
where the radicals are defined as follows:
R³ is selected from among hydrogen and unbranched or branched C₁-C₁₀-alkyl,
R⁴ is selected from among hydrogen and unbranched or branched C₁-C₁₀-alkyl.
R⁵ is selected from among unbranched or branched C₁-C₁₀-alkyl and C₃-C₁₂-cycloalkyl.

4. The use according to claim 2, wherein R¹ is hydrogen or methyl.

5. The use according to claim 2, wherein R² is hydrogen.

6. The use according to claim 3, wherein R³ is hydrogen or methyl.

7. The use according to claim 3, wherein R⁴ is hydrogen.

8. The use according to claim 1, wherein the at least one ethylene copolymer wax has been at least partially neutralized by a basic alkali metal compound or an amine.

9. The use according to claim 1, wherein the at least one ethylene copolymer wax has been at least partially neutralized by an amine, where at least one amine is selected from ammonia, N-alkylethanolamines, alkanolamines or polyamines.

10. A process for the treatment of wastewater, which comprises treating wastewater with one or more dispersions of claim 1.

11. A process according to claim 10, wherein solids which settle or float are separated off after the treatment of the wastewater with the one or more aqueous dispersions.

12. A process for preparing aqueous dispersions of claim 1, which comprises dispersing the one or more ethylene copolymer waxes in water in the presence of at least one basic substance.

13. An aqueous dispersion comprising at least one partially neutralized ethylene copolymer wax selected from ethylene copolymer waxes which comprise, as comonomers in copolymerized form,
(B) from 26.1 to 39% by weight of at least one ethylenically unsaturated carboxylic acid and
(C) from 61 to 73.9% by weight of ethylene,
and ethylene copolymer waxes which comprise, in copolymerized form,
(A′) from 20.5 to 38.9% by weight of at least one ethylenically unsaturated carboxylic acid,
(B′) from 60 to 79.4% by weight of ethylene and
(C′) from 0.1 to 15% by weight of at least one ethylenically unsaturated carboxylic ester.

14. An ethylene copolymer wax comprising, as comonomers in copolymerized form,
26.1 to 39% by weight of at least one ethylenically unsaturated carboxylic acid and 61 to 73.9% by weight of ethylene.

15. An ethylene copolymer wax comprising, as comonomers in copolymerized form,
20.5 to 38.9% by weight of at least one ethylenically unsaturated carboxylic acid,
79.4 to 60% by weight of ethylene and
0.1 to 15% by weight of at least one ethylenically unsaturated carboxylic ester.

16. The use according to claim 2, wherein at least one ethylene copolymer wax has been at least partially neutralized by an amine, where at least one amine is selected from ammonia, N-alkylethanolamines, alkanolamines or polyamines.

17. The use according to claim 3, wherein at least one ethylene copolymer wax has been at least partially neutralized by an amine, where at least one amine is selected from ammonia, N-alkylethanolamines, alkanolamines or polyamines.

18. An ethylene copolymer wax comprising, as comonomers in copolymerized form:
26.1 to 39% by weight acrylic acid or methacrylic acid, and 61 to 73.9% by weight ethylene; or
20.5 to 38.9% by weight of at least one ethylenically unsaturated carboxylic acid,
79.4 to 60% by weight of ethylene and 0.1 to 15% by weight of at least one ethylenically unsaturated carboxylic ester.

19. The ethylene copolymer of claim 18, comprising a melt flow rate of 5 to 20 g/10 min. measured at 160° C. under a load of 325 g in accordance with EN ISO 1133 and an acid number of 115 to 230 mgKOH/g of wax in accordance with DIN 53402.

20. The ethylene copolymer of claim 19, comprising a density from 0.92 to 0.99 g/cm³ in accordance with DIN 53429.
